(19) United States
(12) Patent Application Publication
(10) Pub. No.: US 2024/0219905 A1
(43) Pub. Date: Jul. 4, 2024

(54) AUTONOMOUS VEHICLE MISSION INTERRUPTION AND MISSION CONTINUATION

(71) Applicant: GM Cruise Holdings LLC, San Francisco, CA (US)

(72) Inventors: Spyros Maniatopoulos, San Francisco, CA (US); Andrew Robinson, San Francisco, CA (US); Ashish Bhatnagar, Redwood City, CA (US); Joshua Leighton, Berkeley, CA (US)

(73) Assignee: GM Cruise Holdings LLC, San Francisco, CA (US)

(21) Appl. No.: 18/149,526

(22) Filed: Jan. 3, 2023

(51) Int. Cl. G05D 1/00; G05D 1/02

(52) U.S. Cl. CPC G05D 1/0077; G05D 1/0212; G05D 1/0272; G05D 2201/0213

(57) ABSTRACT

Autonomous vehicles may encounter situations prompting the autonomous vehicle to execute a stopping maneuver, or receive user input from a passenger of the autonomous vehicle that may cause the autonomous vehicle to execute a stopping maneuver (that is not part of nominal planning of the present mission of the autonomous vehicle). In some cases, the autonomous vehicle's mission may be interrupted. Such situations and user input may be diverse. Also, there may be many kinds of stopping maneuvers that the autonomous vehicle can execute in response to the situation or user input. Monitoring for the situations and user input, managing mission interruptions, and performing continuation of a mission can be non-trivial tasks to perform gracefully and effectively.

### BACKGROUND

### Technical Field

The present disclosure generally relates to autonomous vehicles (AVs) and, more specifically, to mission interruption and mission continuation for AVs.

### Introduction

AVs, also known as self-driving cars, and driverless vehicles, may be vehicles that use multiple sensors to sense the environment and move without human input. Automation technology in AVs may enable vehicles to drive on roadways and to accurately and quickly perceive the vehicle's environment, including obstacles, signs, and traffic lights. Autonomous technology may utilize geographical information and semantic objects (such as parking spots, lane boundaries, intersections, crosswalks, stop signs, and traffic lights) for facilitating vehicles in making driving decisions. The vehicles can be used to pick-up passengers and drive the passengers to selected destinations. The vehicles can also be used to pick-up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a planning stack and a control stack for an AV, according to some aspects of the disclosed technology;

FIG. 2 illustrates triggers, fallback manager, escalation policies, and planners in planning stack, according to some aspects of the disclosed technology;

FIGS. 3A-3B are flow diagrams of an exemplary computer-implemented method for mission interruption and mission continuation, according to some aspects of the disclosed technology;

FIG. 4 is a flow diagram for an exemplary computer-implemented method for handling different triggers detected at different times, according to some aspects of the disclosed technology;

FIG. 5A is a flow diagram illustrating an exemplary computer-implemented method for handling different triggers, according to some aspects of the disclosed technology;

FIG. 5B is a flow diagram illustrating another exemplary computer-implemented method for handling different triggers, according to some aspects of the disclosed technology;

FIG. 6 illustrates an example system environment that may be used to facilitate AV operations, according to some aspects of the disclosed technology; and

FIG. 7 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs can provide many benefits. For instance, AVs may have the potential to transform urban living by offering an opportunity for efficient, accessible, and affordable transportation. An AV may be equipped with various sensors to sense the environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. The AV may create planned paths and/or trajectories based on map information, localization, data from perception, and data from prediction. Subsequently, planned path(s) and/or trajectories can be sent to (vehicle) controls to control the AV (e.g., for steering, accelerating, decelerating, braking, etc.) according to the planned path. Vehicle controls may be referred to herein as controls or controller.

The operations of perception, prediction, planning, and control at an AV may be implemented using a combination of hardware and software components. For instance, an AV stack or AV compute process performing the perception, prediction, planning, and control may be implemented as software code or firmware code. The AV stack or AV compute process (the software and/or firmware code) may be executed on one or more processor(s) (e.g., general processors, central processors (CPUs), graphical processors (GPUs), digital signal processors (DSPs), ASIC, etc.) and/or any other hardware processing components on the AV. Additionally, the AV stack or AV compute process may communicate with various hardware components (e.g., on-board sensors and control system of the AV) and/or with an AV infrastructure over a network. In some cases, the AV stack may include a layered arrangement of stacks, including stacks such as a perception stack, a prediction stack, a planning stack, and a control stack.

A fleet of AVs may be managed by a fleet management system to complete a variety of operational assignments, such as picking up passengers, dropping off passengers, picking up deliveries, dropping off deliveries, and navigating to a launch/maintenance facility. Based on user demand and requests for the fleet, different AVs may be assigned to complete various operational assignments. In some cases, an operational assignment can correspond to a trip that is requested and specified by a rider or user/customer of an AV-enabled service. For instance, a rider may request a trip where the rider may be picked up at location X and dropped off at location Y. Upon receipt of the request of the trip, the fleet management system may generate one or more operational assignments that can fulfill the request of the trip. The fleet management system can review availability of the fleet to assign the one or more operational assignments to one or more AVs. Scheduling and assignment performed by the fleet management system may be optimized for efficiency or other suitable factors. An AV in the fleet of AVs may be selected and scheduled by the fleet management system to complete one or more operational assignments.

Dispatch service of the fleet management system may request the AV to perform missions, one-at-a-time, to complete a given operational assignment. A mission may correspond to a leg (e.g., a part, or a portion) of an operational assignment. Dispatch may be responsible for sending missions to the AV to complete a given operational assignment, and performing (fleet-level) optimizations that generate the missions.

In some cases, a remote assistance service of the fleet management system may monitor statuses of the AVs in the fleet, connect with AVs and/or the passengers in the AVs through remote assistance sessions, and resolve issues with the AVs and/or passengers in the AV. In some cases, dispatch may send a new mission to the AV to complete as part of a response to an outcome of a remote assistance session.

A mission can be a leg or a portion of an operational assignment assigned to the AV. A mission can be a request for the planning stack of the AV to stop at or drive past a waypoint. The waypoint can be defined by a location (e.g., defined as a polygon in space). In some cases, a mission may have ranked, backup waypoints. Once the AV drives past or stops at the waypoint (or one of its backups), the mission can be considered complete, and a new mission may be launched for, sent to, or requested of, the AV. The planning stack may have a mission manager that can evaluate whether a mission is complete or not.

The planning stack of the AV may break down the mission into one or more local goals or scenarios in furtherance of completing the mission. Scenarios can be tasks for the planning stack to execute, pursuant to completing a given mission. Examples of scenarios can include: such as lane changes, making a right-turn, driving forward for 1000 meters, pulling over to the right most lane, etc. The planning stack may have a scenario manager to generate scenarios for a given mission, and instruct a specific planner to execute or complete a scenario.

AVs may encounter situations prompting the AV to execute a stopping maneuver, or receive user input from a passenger of the AV that may cause the autonomous vehicle to execute a stopping maneuver (e.g., one that is not part of nominal planning of the present mission of the AV). In some cases, the AV's mission may be interrupted. Such situations and user input may be diverse. Also, there may be many kinds of stopping maneuvers that the AV can execute in response to the situation or user input. Monitoring for the situations and user input, managing mission interruptions, and performing continuation of a mission can be non-trivial tasks to perform gracefully and effectively.

During operation, an AV may be triggered by different situations that would prompt the planning stack of AV to begin planning a stopping maneuver. One example of a situation is when the AV enters a degraded state, and a fallback planner corresponding to the degraded state (e.g., due to a collision and/or hardware or software failure) may take over control of the AV to complete a (graceful) stopping maneuver (e.g., pulling over as soon as practicable and as safely as possible). Another example of a situation is when the AV detects a loss in connectivity with the fleet management system, and a primary planner may be instructed to complete a (graceful) stopping maneuver (e.g., find a convenient stopping location to park). Yet another example of a situation is when the AV detects a door of the AV is open while the vehicle is in motion, and a primary planner may be instructed to complete a (graceful) stopping maneuver (e.g., come to a stop as quickly and safely as possible, or find a convenient stopping location to pull over).

In some cases, a passenger of an AV may provide user input via a user device to end a trip prematurely, or stop the AV as soon as possible. The user input may cause a primary planner of the AV to complete a (graceful) stopping maneuver (e.g., find a convenient stopping location to drop-off passenger(s)). In yet some other cases, a passenger of an AV may provide user input via a user device to request for help from remote assistance. Remote assistance may request the AV to complete a (graceful) stopping maneuver (e.g., find a convenient stopping location away from traffic).

In response to various situations and user input, a variety of stopping maneuvers may be executable by the planning stack of the AV. Stopping maneuvers may be driving maneuvers that allow the AV to come to a stop gracefully with safety in mind. Stopping maneuvers may have different levels of urgency in terms of expected time and distance traveled before coming to a stop. Some stopping maneuvers may be more appropriate for certain situations or certain user inputs. If the planning stack is unable to complete a requested stopping maneuver, it may be appropriate to request the planning stack to escalate to a more urgent (e.g., pressing or critical) stopping maneuver.

Because the situations and user input can be diverse, a fallback manager can be implemented to subscribe to a set of input signals and listen for triggers that may become active in the input signals due to the AV encountering a situation or receiving certain user input. The fallback manager can advantageously serve as a first responder to triage an active trigger and cause an appropriate part of the planning stack to respond to the active trigger appropriately. The fallback manager can also address and arbitrate between and respond to multiple active triggers being present, and cause the planning stack to respond appropriately.

To assist the fallback manager in determining an appropriate stopping maneuver in response to an active trigger, a taxonomy of stopping maneuvers and corresponding triggers can be provided for the fallback manager to effectively find appropriate stopping maneuvers in response to various triggers. In addition to the taxonomy, triggers are associated with escalation policies so that the fallback manager can monitor whether a given stopping maneuver is complete or can be completed, and escalate to a next stopping maneuver if an escalation policy specifies escalation. In some cases, the fallback manager may proactively escalate to a next stopping maneuver if the given stopping maneuver cannot be completed within a prescribed time interval or distance.

When a mission has been interrupted, the fallback manager can assist in determining whether the mission can be continued, or if a new mission is to be completed. Additionally, if the active trigger is transient, the fallback manager can detect whether a trigger has become inactive, cease executing a stopping maneuver, and allow the mission to continue. In some cases, after the AV has completed a stopping maneuver and has come to a stop, if the active trigger has become inactive, the fallback manager can allow the mission to continue. The fallback manager may assume that, since the active trigger is no longer active, that the AV has self-recovered.

Various embodiments herein and their advantages may apply to a wide range of vehicles (e.g., semi-autonomous vehicles, vehicles with driver-assist functionalities, etc.), and not only AVs.

### Exemplary Planning Stack and Control Stack of an AV

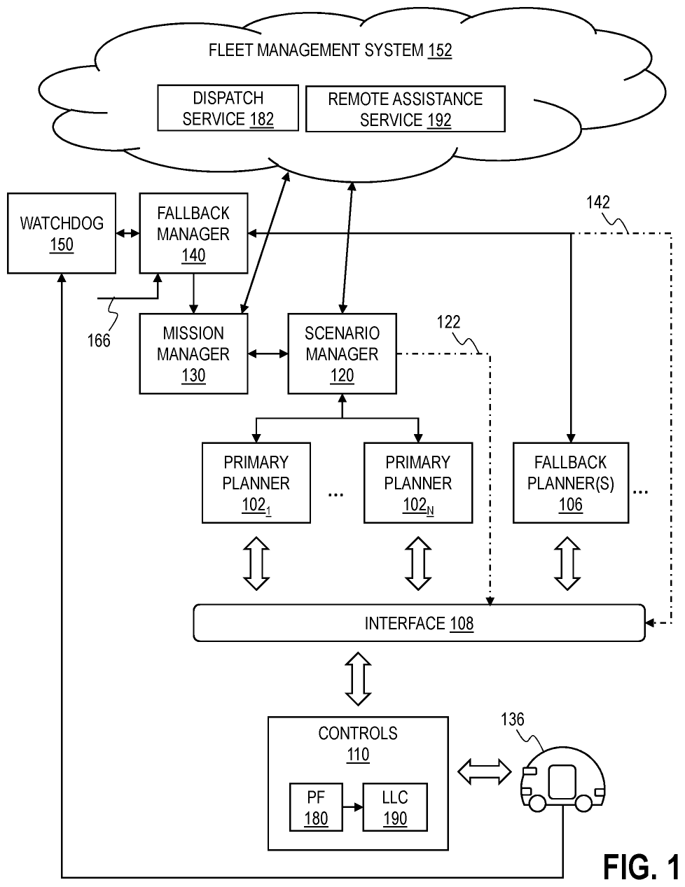

FIG. 1 illustrates a planning stack and a control stack for an AV, according to some aspects of the disclosed technology. The planning stack may include a plurality of planners, which can be specialized to perform certain tasks or operate under certain conditions. An interface 108 can be provided to organize and streamline communications and data streams from the planners to the control stack. The control stack can include controls 110, which can send commands to control vehicle control hardware of AV 136.

The planning stack may include multiple (two or more) primary planners. The planning stack may include one or more primary planners, which are illustrated as primary planners 102₁-102_{N}. While two primary planners are shown, it is envisioned by the disclosure that some planning stacks may include one planner, and some planning stacks may include more than two planners. The primary planners may be designed to generate plans for different scenarios or tasks. The primary planners may be designed with different driving goals. For instance, one primary planner may be specialized in generating plans for the AV in structured, nominal driving (e.g., tasks or scenarios that involve the AV driving forward). Another primary planner may be specialized in generating plans for the AV in unstructured, freespace driving. Yet another primary planner may be specialized in generating plans for the AV to drive in reverse. Yet a further primary planner may be specialized in producing instructions for tasks or scenarios that involve the AV staying still. Other primary planners may be specialized in generating plans for completing other tasks such as: parking, maneuvering around inside a building structure, pulling over, driving on a highway, driving on a freeway, merging into another lane, driving off-road, driving in inclement weather conditions, etc.

As used herein, a plan can include several parts or components, such as one or more trajectories, a target gear request, a blinker light request, a hazard light request, a braking request, a honking request. A plan can include requests or instructions (software) for vehicle controls in addition to one or more (reference) trajectories. A trajectory can include a contiguous line that connects a starting point/pose of the vehicle and an end point/pose of the vehicle. The line may be defined within a two-dimensional representation of the driving surface or in a three-dimensional representation of the environment surrounding the vehicle. The line may have a corresponding length. Different portions or segments of the line may have different curvatures. The line may have an associated directionality. A trajectory may be multidimensional. Besides including a line, a trajectory may include higher order derivatives such as velocity, acceleration, curvature, curvature rate, etc.

Depending on the task, scenario, or goal, scenario manager 120 can activate one of the primary planners to produce plans. In some embodiments, only one of the primary planners is actively producing plans at a given point in time. Primary planners can be computationally resource intensive. Unless a given primary planner is needed, or is expected to be active or take control imminently, a given primary planner may be powered down or be inactivated. In some embodiments, two or more primary planners are actively producing plans. In some embodiments, two primary planners may not operate simultaneously during an operation of the vehicle.

Scenario manager 120 may receive information on a given scenario to be performed by the vehicle, and may select and instruct one of the primary planners to generate plans for the scenario. All outputs of the planners may be coupled to the interface 108. Plans generated by the planners can thus be provided to the interface 108. Scenario manager 120 may transmit a first selection signal 122 to interface 108 to select the plan from the primary planner that is in control of the AV to be provided to controls 110. In some cases, fleet management system 152 (e.g., remote assistance service 192) may communicate with scenario manager 120 to assess the state of the planning stack of AV 136 (e.g., whether a scenario has been successfully completed, or what is the current scenario being executed).

Upstream of the scenario manager 120 may be a mission manager 130. Fleet management system 152 (e.g., dispatch service 182) may transmit missions to be completed (e.g., one-at-a-time), for the AV 136 to complete an operational assignment. The mission manager 130 can be responsible for executing a nominal mission, and breaking up the mission into tasks/scenarios/goals. Mission manager 130 may transmit the tasks/scenarios/goals to scenario manager 120. Scenario manager 120 may be aware of the mission that triggered the scenario to be executed by the primary planners. Mission manager 130 may receive feedback information from scenario manager 120 on the status of a given scenario being completed for the given mission. In some cases, fleet management system 152 (e.g., dispatch service 182) may communicate with mission manager 130 to assess the state of the planning stack of AV 136 (e.g., whether a mission has been successfully completed).

Primary planners 102 may be designed to operate when the vehicle is fully operational. In some cases, the planning stack may include one or more fallback planners, shown as fallback planner(s) 106. The fallback planner(s) 106 may be provided and designed to take control of the vehicle when the vehicle is in a degraded state. In some embodiments, there may be multiple fallback planners for different corresponding degraded states, e.g., each implemented to take over control of the AV when the AV is in a corresponding degraded state. Degraded state of the vehicle can occur in scenarios where the vehicle is no longer expected to be fully operational. Such scenarios can occur if there is a software and/or hardware failure or fault of the vehicle. Fallback manager 140 may monitor whether the AV 136 is in a degraded state (or monitor for one or more degraded states), and determine whether to utilize one of the primary planners 102 or one of the fallback planner(s) 106. Dependencies of fallback planner(s) 106 may be orthogonal to dependencies of a primary planner (e.g., primary planners 102₁-102_{N}), and would take over control of the AV if the AV is in a degraded state. To ensure that switching between a primary planner and a fallback planner is done quickly, at least one of the primary planners and the fallback planner may generate plans simultaneously during operation of the vehicle (e.g., at least one of the primary planners 102₁-102_{N} and the fallback planner(s) 106 are both producing plans at the same time). Interface 108 may receive plans from at least one of the primary planners 102₁-102_{N} and the fallback planner(s) 106. In some embodiments, the fallback manager 140 may manage the fallback planner(s) 106, and output a second selection signal 142 to interface 108, to select the plans from the fallback planner that is in control of the AV to be provided to controls 110.

The control stack includes controls 110, which can receive plans generated by the planning stack upstream of the controls 110 and generate commands to control vehicle hardware controls of AV 136 based on the received plans. Examples of vehicle hardware controls may include: vehicle gear control, vehicle blinker light control, vehicle hazard light control, vehicle steering control, vehicle brake control, vehicle motor controls, and vehicle horn control. Controls 110 can send commands to vehicle hardware controls to cause a gear of AV 136 to change, cause the AV 136 to brake, cause the AV 136 to turn steering by a certain amount, cause the AV 136 to accelerate by a certain amount, cause the horn of the AV 136 to honk, etc.

In some embodiments, controls 110 may include a path follower 180 and low-level controls 190. Path follower 180 may generate a local path for the vehicle to take. The local path may be optimized based on tracking error of the local path relative to the output trajectory of a plan received from the unified interface 108. Path follower 180 may produce a local path that follows the output trajectory as closely as possible, given certain constraint(s). Constraints can include: comfort, speed, feasibility, lateral acceleration, curvature, curvature rate, lateral jerk, etc. Low-level controls 190 may generate the commands to the vehicle hardware controls based on the local path produced by path follower 180. For instance, low-level controls 190 may translate the local path into desired acceleration and velocity information, and produce motor control commands for the vehicle hardware controls. Low-level controls 190 may determine desired gear, and produce gear control commands to change the gear of the vehicle. Low-level controls 190 may determine whether hazard lights are to be turned on, and produce commands to turn on the hazard lights.

AV 136 may encounter a variety of situations and/or user input that prompts the AV 136 to execute a specific stopping maneuver. There may be a variety of stopping maneuvers that the AV 136 may need to execute (using the planning stack) in response to the situation and/or user input. In addition, the exact planner in the planning stack that needs to be used to execute a given stopping maneuver may differ from one stopping maneuver to another stopping maneuver. For instance, one of the primary planners may be able to plan a stopping maneuver involving finding a parking spot and parking in the parking spot. In another instance, one of the fallback planners may be used to plan a stopping maneuver involving an in-lane stop or open-loop braking. Phrased differently, the planning stack may have multiple subsystems that are targeted for certain specific stopping maneuvers.

A preferred component in the planning stack may be expected to be aware of all the various planners in the planning stack, in order to orchestrate an appropriate stopping maneuver in response to a situation and/or user input. The preferred component may be tasked to delegate a given stopping maneuver to a selected subsystem of the planning stack. As illustrated in the FIG. 1, fallback manager 140 is the key handler that controls the planning stack, e.g., dictating whether one of the primary planners or one of the fallback planners is in control of AV 136. Fallback manager 140 can control which one of the planners is in control of the AV 136, and can also receive feedback information from the planners. By design, the primary planners and the fallback planners can be agnostic to each other, or how the planning stack is decomposed of different planners. For these reasons, the fallback manager 140 can be the preferred component that can cause appropriate stopping maneuvers to be executed by one of the planners in the planning stack.

For similar reasons, the fallback manager 140 can be the preferred component to monitor for diverse situations and/or user input that may cause the planning stack to execute a stopping maneuver. The fallback manager 140 can be a first responder to triage and decide on an appropriate stopping maneuver for the planning stack to execute.

The fallback manager 140 can perform mapping of a given trigger to a specific stopping maneuver. Once the specific stopping maneuver is identified, the fallback manager 140 can effectively select which of the subsystems in the planning stack to delegate the performance or execution of the stopping maneuver. Once a stopping maneuver corresponding to a trigger has been delegated to a chosen subsystem in the planning stack, the chosen subsystem is responsible for executing the appropriate stopping maneuver.

In some cases, the fallback manager 140 can perform mapping of a given trigger to a specific subsystem in the planning stack. Once the specific subsystem is identified, the fallback manager 140 can effectively delegate the performance or execution of the stopping maneuver to the specific subsystem. The fallback manager 140 can decide whether there is a need to fail-over to the secondary planning stack or tertiary planning stack, based on the nature of the trigger (e.g., degraded states of operation). The chosen subsystem may then be responsible for selecting the appropriate stopping maneuver based on the trigger. For example, a mission manager may decide to execute a pullover maneuver in response to a trigger activated by a passenger's request to end the ride early.

To monitor for such situations and/or user input, watchdog 150 may be included to monitor state information of the AV 136 (and control stack of the AV 136) and output or publish signals. Other component(s) may be included to monitor state information of the AV 136 and output or publish signals 166. Watchdog 150 and the other component(s) may publish signals, which can correspond to one or more degraded states, to one or more subscribers, such as the fallback manager 140. The signals can represent various triggers or flags (i.e., situations and/or user input) that can cause the planning stack to execute an appropriate stopping maneuver. If watchdog 150 or the other component(s) determine that certain condition(s) corresponding to a signal are present, a signal may be latched as “active”, causing a trigger to have an active state. If watchdog 150 determines that certain condition(s) corresponding to the signal are not present, then the signal may be latched as “inactive”, causing a trigger to have an inactive state. Watchdog 150 may periodically monitor for presence of conditions, e.g., by routinely querying for state information of the AV 136. In some cases, watchdog 150 may monitor for declared fault signals (e.g., from interface 108, the planning stack, and the control stack) to set state states of certain signals. Fallback manager 140 can subscribe to the (input) signals maintained by watchdog 150 and/or other component(s), and listen for active trigger(s) that may cause the planning stack to respond with an appropriate stopping maneuver.

### Exemplary Triggers and Corresponding Escalation Policies, and System to Manage the Triggers and Escalation Policies

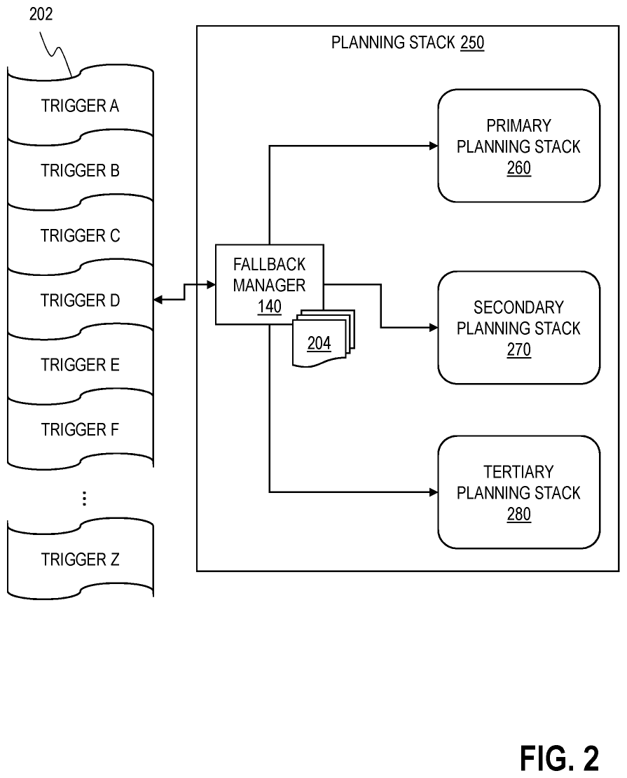

FIG. 2 illustrates triggers, fallback manager, escalation policies, and planners in the planning stack, according to some aspects of the disclosed technology. Planning stack 250 may include fallback manager 140 to manage two or more subsystems or sub-planning stacks, e.g., primary planning stack 260, secondary planning stack 270, and tertiary planning stack 280. The sub-planning stacks arranged in parallel offer planners that may be designed to operate differently, and in some cases, have orthogonal dependencies. For instance, primary planning stack 260 may be designed to complete a nominal mission, e.g., performing path planning for normal operation of the AV. Secondary planning stack 270 may be designed to perform certain driving maneuvers when the AV is in a first degraded state. Tertiary planning stack 280 may be designed to perform certain driving maneuvers when the AV is in a second degraded state (e.g., a different from and more severe than the first degraded state). Tertiary planning stack may not necessarily be a planning stack per se, but may provide some mechanisms to generate commands for the AV to perform certain driving maneuvers.

Primary planning stack 260 may include mission manager 130, scenario manager 120, and primary planners 102_{1-N} of FIG. 1. Secondary planning stack 270 and tertiary planning stack 280 may include corresponding fallback planners, e.g., fallback planner(s) 106 of FIG. 1.

There are a variety of exemplary signals corresponding to triggers that can be maintained by watchdog 150 of FIG. 1 or other component(s) in the system that can publish and maintain such signals. The (input) signals/triggers are shown as signals 202 (e.g., trigger A, trigger B, trigger C . . . trigger Z). Examples of conditions or events that can cause one or more active signals 202 may include inclement weather conditions, loss of connectivity to fleet management system (e.g., heartbeat loss), grounding of a fleet, seatbelt unbuckled, remote assistance session initiated, vehicle hardware tampering, help button pressed by passenger, passenger end ride early request via the mobile app or in-car tablet, mild collision detected, severe collision detected, vehicle in degraded state A, vehicle in degraded state B, presence of software fault, medical emergency detected, etc.

Fallback manager 140 may listen for active triggers (e.g., triggers latched in an active state) on input signals 202. Fallback manager 140 may be subscribed to the input signals to determine presence of one or more active triggers. In some cases, no triggers are active in input signals 202. In some cases, only one trigger is active in input signals 202. In some cases, two or more triggers are active in input signals 202.

As discussed with FIG. 1, fallback manager 140 can triage one or more active triggers, and determine an appropriate response to the one or more active triggers. An appropriate response to an active trigger may include attempting a specific kind of stopping maneuver that corresponds to the active trigger. In some cases, an appropriate response to an active trigger may include attempting a series or ordered sequence of different stopping maneuvers (each one more urgent than the previous one), based on certain rules or conditions for escalation.

To assist the fallback manager 140, appropriate prescribed responses to the triggers can be provided in the form of a stopping maneuver taxonomy. The stopping maneuver taxonomy can reference triggers, and link individual triggers to a suitable or appropriate response, i.e., a specific kind of stopping maneuver. Examples of stopping maneuvers may include: comfortable non-urgent pull over, find a parking spot and pull over, (gracefully and safely) pull over even if the AV is double parked, (gracefully and safely) park in shoulder of road, (gracefully and safely) stop as soon as possible as long as the AV is not within an intersection or in an oncoming lane of traffic, emergency stop, etc.

Different triggers may be ranked from least urgent (or lowest priority) to most urgent (highest priority) in the taxonomy. Different kinds of stopping maneuvers may be ranked from least urgent to most urgent in the taxonomy.

Additionally, escalation policies 204 may be linked to certain triggers or classes of triggers so that appropriate escalation of stopping maneuvers can be attempted by the AV. In some cases, escalation policies may be linked to an initial stopping maneuver being attempted by the AV.

One exemplary escalation policy in escalation policies 204 may include a stopping maneuver that corresponds to a specific trigger. For example, an escalation policy may include the emergency stopping maneuver if, for example, a pullover maneuver fails.

Another exemplary escalation policy in escalation policies 204 may include a series or ordered sequence of stopping maneuvers to attempt with certain conditions for escalation. Such series or ordered sequence of stopping maneuvers may be referred to as an escalation ladder. The stopping maneuvers may be ordered from least urgent to most urgent. An example of an escalation policy having an escalation ladder may include the following ordered sequence of stopping maneuvers:
(1) first stopping maneuver: attempt a find a parking spot and pull over stopping maneuver,
   Condition for escalation: if first stopping maneuver is not complete after 500 meters or after 45 seconds, attempt>>
(2) second stopping maneuver: (gracefully and safely) attempt a pull over even if the AV is double parked, and
   Condition for escalation: if second stopping maneuver is not complete after 200 meters or after 15 seconds, attempt>>
(3) third stopping maneuver: (gracefully and safely) stop as soon as possible as long as the AV is not in an intersection or in a lane with oncoming traffic.

Another exemplary escalation policy in escalation policies 204 may include instructions and conditions for proactive escalation. For example, the escalation policy may request the planning stack to determine whether the planning stack is expected to be able to complete a first stopping maneuver within 500 meters. If the planning stack does not expect to be able to complete the first stopping maneuver within 500 meters, the fallback manager 140 (or in some cases, a mission manager 130) implementing the escalation policy may instruct the planning stack to skip attempting the first stopping maneuver, and attempt a second stopping maneuver in the escalation ladder.

A certain stopping maneuver in an escalation policy corresponding to a trigger may be designated to be performed by a specific planning stack (e.g., one of primary planning stack 260, secondary planning stack 270, and tertiary planning stack 280). Based on the particular kind of stopping maneuver to be attempted (as specified in the escalation policy), the fallback manager 140 may determine the appropriate planning stack to perform the particular kind of stopping maneuver, and instruct the appropriate planning stack accordingly. Escalating to a next stopping maneuver in the escalation policy may result in failing over to a different planning stack (or subsystem in the planning stack), if a different planning stack is to perform the next stopping maneuver.

If the escalation policy includes an escalation ladder, the fallback manager 140 may monitor or evaluate completion status of a stopping maneuver, and monitor or evaluate the conditions for escalation, to determine whether the next stopping maneuver in the ladder is to be attempted. The sub-planning stacks may provide feedback information to fallback manager 140 in regards to, e.g., completion status of a stopping maneuver, readiness to perform a stopping maneuver, whether a planning stack can perform the stopping maneuver within a certain distance or certain period of time.

If sub-planning stacks can provide feedback information in regards to whether a planning stack can perform the stopping maneuver within a certain distance or certain period of time, fallback manager 140 may determine that proactive escalation may be desirable. Fallback manager 140 may proactively escalate to the next stopping maneuver in the escalation ladder if the planning stack does not expect to be able to perform the stopping maneuver within a certain distance or certain period of time.

In some cases, escalation according to the escalation ladder may be performed by the sub-planning stacks or subsystems of the planning stack.

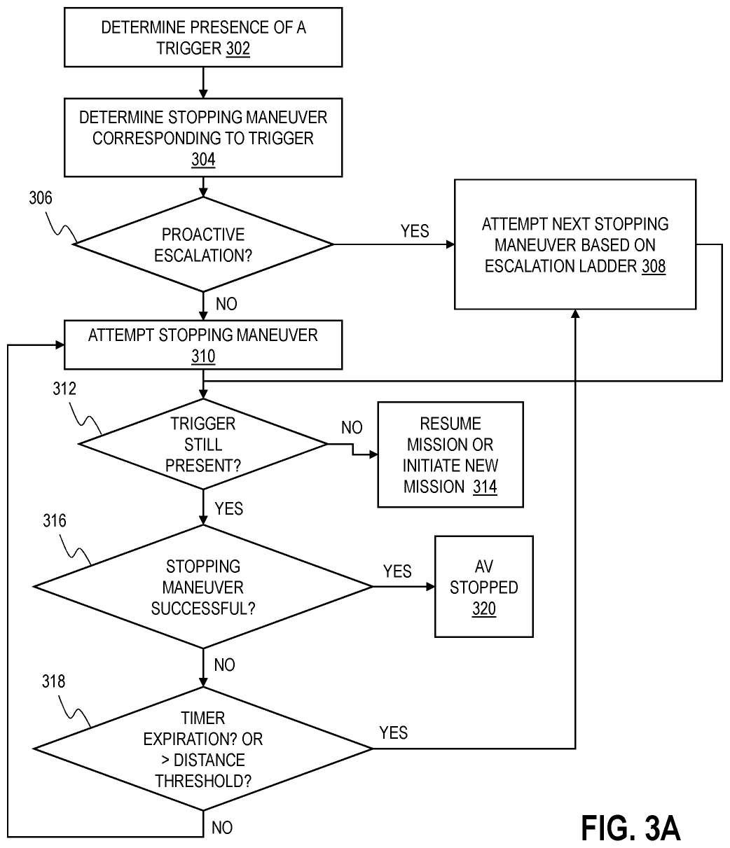

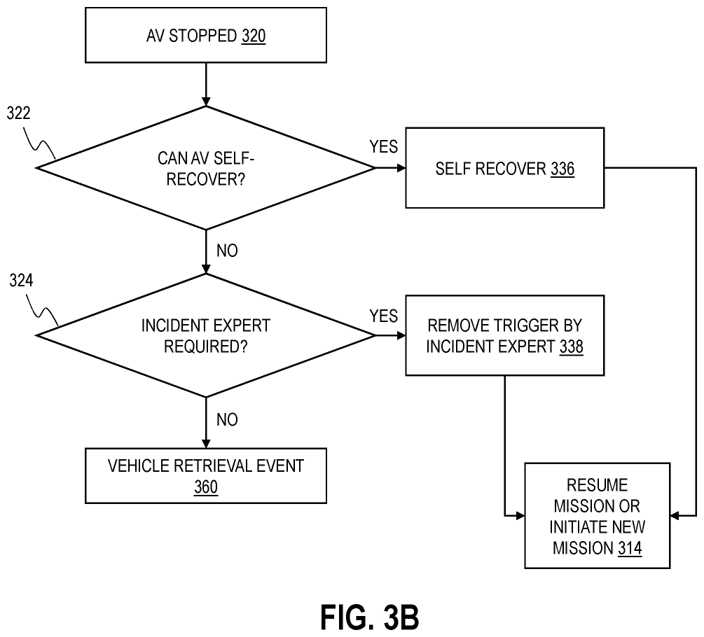

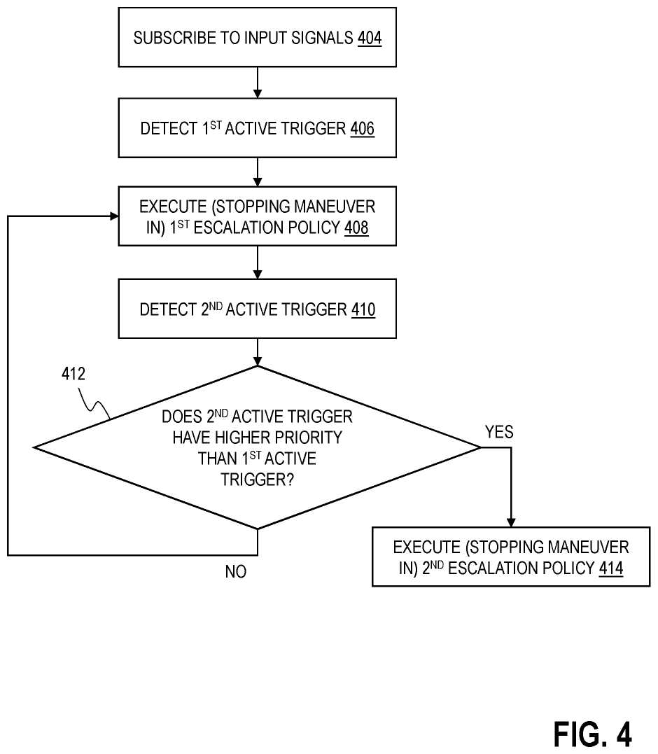

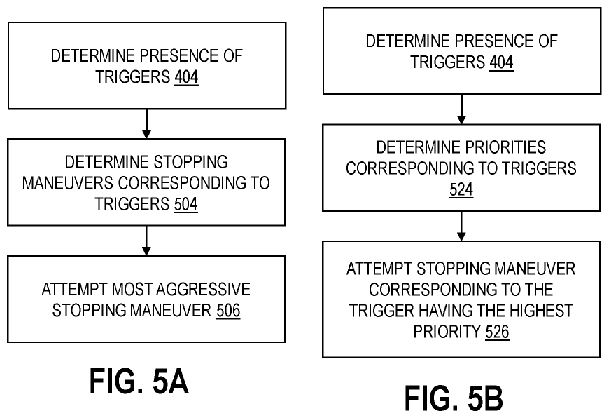

Various methods relating to escalation are illustrated in FIG. 3A. Various methods for handling multiple active triggers are illustrated in FIGS. 4, 5A, and 5B.

### Exemplary Methods for Mission Interruption and Mission Continuation

FIGS. 3A-3B are flow diagrams of an exemplary computer-implemented method for mission interruption and mission continuation, according to some aspects of the disclosed technology. The flow diagrams illustrate some implementations where the fallback manager may map a given trigger to a corresponding stopping maneuver, delegate one of the sub-planning stacks or subsystems of the planning stack to perform the stopping maneuver, and execute or carry out any escalation policies associated with the trigger.

In 302 of FIG. 3A, while the vehicle is completing a mission, fallback manager (e.g., fallback manager 140) may determine the presence of a first trigger. Presence of a first trigger may include determining that the first trigger is in an active state. The fallback manager may listen for active triggers on input signals. Methods and systems for monitoring for active triggers are described with FIGS. 1-2.

In 304, the fallback manager may determine a first stopping maneuver corresponding to the first trigger, e.g., based on a stopping maneuver taxonomy. In some cases, determining a first stopping maneuver comprises determining a stopping maneuver in a first position in the escalation ladder corresponding to the first trigger. In some cases, determining the first stopping maneuver corresponding to the first trigger comprises determining an escalation policy corresponding to the first trigger.

In some cases, escalation policy indicates that proactive escalation can be performed or may be desirable. In 306, the fallback manager may determine whether proactive escalation is appropriate. For instance, the fallback manager may determine an earliest or nearest predicted interval to complete the first stopping maneuver. The predicted interval information may be provided by a sub-planning stack. Interval may include a distance. Interval may include a period of time. The fallback manager may determine that the earliest or nearest predicted interval is insufficient to complete the first stopping maneuver, e.g., according to the escalation policy.

In response to the earliest or nearest predicted interval being insufficient to complete the first stopping maneuver according to the escalation policy (YES path from 306), in 308, the fallback manager may attempt a second stopping maneuver (or next stopping maneuver) based on the escalation policy corresponding to the trigger by causing a planning stack of the vehicle to execute a second stopping maneuver. The method may proceed to 312. Otherwise or the earliest or nearest predicted interval is sufficient to complete the stopping maneuver (NO path from 306), the method may proceed to 310.

In 310, the fallback manager may interrupt the mission by attempting the first stopping maneuver by causing a planning stack of the vehicle to execute the first stopping maneuver. In some cases, if the first stopping maneuver can be executed by a primary stack, the fallback manager may trigger the planning stack of the vehicle to complete the first stopping maneuver as a new goal of the mission (e.g., by sending a new scenario for the scenario manager to execute). In some cases, if the first stopping maneuver can be executed by a secondary planning stack or a tertiary planning stack, the fallback manager may trigger the secondary planning stack or the tertiary planning stack to complete the first stopping maneuver.

In some cases, the active state of the first trigger is transient. In 312, the fallback manager may determine whether the first trigger is still present (or active). If the fallback manager determines the first trigger is no longer present or active (NO path from 312), in 314, the fallback manager may resume the mission. Resuming the mission may include causing the planning stack to cease executing the first stopping maneuver, and optionally executing a goal that continues the mission. Resuming the mission may include returning control to the primary planning stack if a secondary/tertiary planning stack was executing the first stopping maneuver. In some cases, if the fallback manager determines the first trigger is no longer present or active (NO path from 312), in 314, the fallback manager may initiate a new mission. Initiating a new mission may include causing the planning stack to cease executing the first stopping maneuver and executing a goal of the new mission. If the first trigger is still present (YES path from 312), the method may proceed to 316.

In 316, the fallback manager may determine or monitor whether the first stopping maneuver has been executed successfully. If the first stopping maneuver has been executed successfully (YES path from 316), in 320, the AV is stopped. If the first stopping maneuver has not yet been executed successfully (NO path from 316), the method may proceed to 318.

In 318, the fallback manager may check conditions for escalation, e.g., an expiration of a timer or crossing a certain distance threshold before the first stopping maneuver is completed. Conditions may include one or more of: an expiration of a timer or crossing a certain distance threshold. If a plurality of conditions are included as conditions for escalation, the fallback manager may determine escalation is desirable in response to any one of the conditions occurring (the conditions are joined by a logical OR operation). In some cases, the fallback manager may determine escalation is desirable in response to all the conditions occurring (the conditions are joined by a logical AND operation).

In response to crossing a distance traveled threshold or an expiration of a timer before the first stopping maneuver is successfully completed by the vehicle (YES path from 318), in 308, the fallback manager may escalate to a next stopping maneuver in the escalation ladder. Escalation may include attempting a second (or next) stopping maneuver based on an escalation ladder corresponding to the first trigger. The fallback manager may cause the planning stack (or a different planning stack or subsystem of the planning stack) of the vehicle to execute the second stopping maneuver.

The fallback manager may check whether the distance traveled threshold has been crossed by: measuring a distance traveled by the vehicle since attempting the first stopping maneuver began, and checking if the distance traveled exceeds the distance traveled threshold. The fallback manager may include a timer to check expiration of the timer. The timer can measure an amount of time elapsed since attempting the first stopping maneuver began; and the timer can check if the amount of time lapsed exceeds a timer threshold.

In some cases, 312, 316, and/or 318 may be applicable to a second/next stopping maneuver (or additional stopping maneuvers in the escalation ladder) in a similar fashion when the method proceeds to 308. In other words, when the second/next stopping maneuver or other stopping maneuvers in the escalation ladder are being attempted, the method may perform 312, 316, and/or 318.

In some cases, 306 may be applied to the second/next stopping maneuver (or additional stopping maneuvers in the escalation ladder) in a similar fashion before the method proceeds to 308, if proactive escalation is desirable before attempting the second/next stopping maneuver.

In some cases, the first stopping maneuver and the second stopping maneuver may be attempted by different sub-planning stacks. For example, causing the planning stack of the vehicle to execute the first stopping maneuver may include causing a primary planner of the vehicle to execute the first stopping maneuver, and causing the planning stack of the vehicle to execute the second stopping maneuver may include causing a fallback planner of vehicle to execute the second stopping maneuver. Advantageously, the fallback manager can transition between different sub-planning stacks seen in planning stack 250 of FIG. 2.

Once AV is stopped in 320, the fallback manager and in some cases, the individual sub-planning stacks of planning stack 250 of FIG. 2, may enter a workflow for next steps for the interrupted mission, which is illustrated in greater detail in FIG. 3B.

In some cases, in 322, a component of the planning stack may determine if the AV is able to self-recover. If the AV is able to self-recover (YES path from 322), in 336, the component may cause the AV to perform self-recovery. Completing self-recovery may cause the active trigger to be cleared or no longer be present. In some cases, if an active trigger is no longer present or is cleared, then self-recovery may be deemed to be successful. Self-recovery may include running a recovery sequence to troubleshoot and apply a fix to the AV that addresses the trigger. Self-recovery may include running a calibration sequence that addresses the trigger. Once the trigger is cleared after completing the stopping maneuver, the method may proceed to 314 (e.g., resuming the mission or initiating a new mission). If the AV is not able to self-recover (NO path from 322), the method may proceed to 324.

In 324, a component in the planning stack may determine whether an incident expert is required to address the trigger that caused the stopping maneuver to be executed. In some cases, an incident expert is required by default. In some cases, an incident expert may be required for some triggers but not for others.

In some cases, when the mission is interrupted, a component in the planning stack may publish to a fleet management system, e.g., an incident expert or remote assistance agent, the trigger(s), a mission interrupted state, and the stopping maneuver being attempted. The triggers may provide reason(s) explaining why the mission is interrupted. A remote assistance session may be initiated and/or established with the fleet management system, e.g., the incident expert or remote assistance agent. Through the remote assistance session, the incident expert or remote assistance agent may obtain information about the AV, converse with the passenger(s), and/or monitor the cabin and the AV's surroundings to determine an appropriate resolution to the interrupted mission.

If an incident expert is required (YES path from 324), the incident expert or remote assistance agent can evaluate the AV via the remote assistance session, and provide a resolution if applicable. A resolution may include finally ending the trip for the passenger. A resolution may include adding a new destination or new trip for the passenger. A resolution may include adding additional waypoint(s) to the present trip. In 338, the incident expert or remote assistance agent may remove or clear the trigger if the resolution is satisfactory and/or addresses the trigger. The AV (e.g., watchdog 150 of FIG. 1) may receive a request to clear or remove the trigger from the incident expert. If the trigger is removed or cleared or in response to determining by the fallback manager that the trigger is no longer present or is inactive, the method may proceed to 314.

In some cases, in 314, the incident expert may specify the new mission to be initiated. In some cases, the incident expert may specify a new goal for the scenario manager to complete. If applicable, in response to determining that the trigger is no longer present, in 314, a component in the planning stack may publish a mission active state to the fleet management system.

In some cases, if the AV cannot self-recover (and optionally an incident expert is not required), in 360, a component in the planning stack can trigger a vehicle retrieval event, e.g., by transmitting a request to a fleet management system to arrange for the AV to be retrieved (e.g., by a human operator).

In some cases, triggers may become active at different times or in sequence. The triggers may conflict with each other or may be associated with conflicting or incompatible escalation policies. Generally, if another trigger with higher priority becomes active, a fallback manager may transition to respond to the other trigger with a potentially more urgent stopping maneuver. The fallback manager may routinely monitor and listen to input signals, even after a trigger has become active.

Referring back to FIG. 3A, in some cases, 312 is being performed in the background, where the presence of one or more triggers is monitored continuously or checked at a certain frequency. This may mean that 312 may be performed even after a stopping maneuver is completed successfully and the AV has stopped (in 320). This may mean that 312 may be performed even after the AV is carrying out the flow illustrated in FIG. 3B. This may also mean that 312 may be performed while and after the next stopping maneuver is attempted (in 308). This may also mean that 312 may be performed after the next stopping maneuver is completed successfully and the AV has stopped (in 308).

### Exemplary Methods to Address Multiple Active Triggers

FIG. 4 is a flow diagram for an exemplary computer-implemented method for handling different triggers detected at different times, according to some aspects of the disclosed technology. In some cases, different triggers may have different associated escalation policies. The different escalation policies may have different stopping maneuvers. In 404, a fallback manager may subscribe to input signals representing active and inactive triggers. In 406, while the AV is completing a mission, the fallback manager may detect a first active trigger in the input signals. In 408, the fallback manager may execute a first escalation policy corresponding to the first active trigger. For instance, the fallback manager may interrupt the mission by causing a planning stack of the AV to execute one or more first stopping maneuvers according to the first escalation policy corresponding to the first active trigger. In 410, while the planning stack is executing the first escalation policy, the fallback manager may detect a second active trigger. The second active trigger may have a higher priority than the second trigger. In 412, the fallback manager may determine if the second active trigger has a higher priority than the first active trigger. If the second active trigger has a higher priority than the first active trigger (YES path from 412), then the fallback manager may cause the planning stack of the vehicle to execute one or more second stopping maneuvers according to a second escalation policy corresponding to the first active trigger. Otherwise or if the second active trigger does not have a higher priority than the first active trigger (NO path from 412), the method may proceed to 408 (e.g., continue executing the first escalation policy).

In some cases, multiple triggers may become active at or around the same time. The triggers may conflict with each other or may be associated with conflicting or incompatible escalation policies. Generally, if one active trigger has a higher priority than another active trigger, the escalation policy or stopping maneuver corresponding to the active trigger with the higher priority can be executed. If a stopping maneuver corresponding to a first active trigger is more urgent than another stopping maneuver corresponding to a second active trigger, then the more urgent stopping maneuver can be executed.

FIG. 5A is a flow diagram illustrating an exemplary computer-implemented method for handling different triggers, according to some aspects of the disclosed technology. In 404, a fallback manager may subscribe to input signals representing active and inactive triggers, and while the vehicle is completing the mission, presence of triggers (e.g., presence of a first trigger and presence of a second trigger) can be detected. In 504, the fallback manager may determine a first stopping maneuver corresponding to the first trigger, and a second stopping maneuver corresponding to the second trigger. In 506, the fallback manager may attempt a stopping maneuver that is the most urgent. 504 and 506 may be also applicable to escalation policies having different levels of urgency. For example, the fallback manager may attempt the first stopping maneuver (and not the second stopping maneuver) if the first stopping maneuver is more urgent than the second stopping maneuver.

FIG. 5B is a flow diagram illustrating another exemplary computer-implemented method for handling different triggers, according to some aspects of the disclosed technology. In 404, a fallback manager may subscribe to input signals representing active and inactive triggers, and while the vehicle is completing the mission, presence of triggers (e.g., presence of a first trigger and presence of a second trigger) can be detected. In 524, the fallback manager may determine priorities corresponding to the triggers, e.g., priority associated with the first trigger and priority associated with the second trigger. In 526, the fallback manager may attempt the stopping maneuver corresponding to the trigger with the highest priority (and not the stopping maneuvers corresponding to other lower priority triggers). For example, the fallback manager may attempt the first stopping maneuver corresponding to the first trigger if the first trigger has a higher priority than the second trigger.

### Exemplary AV Management System

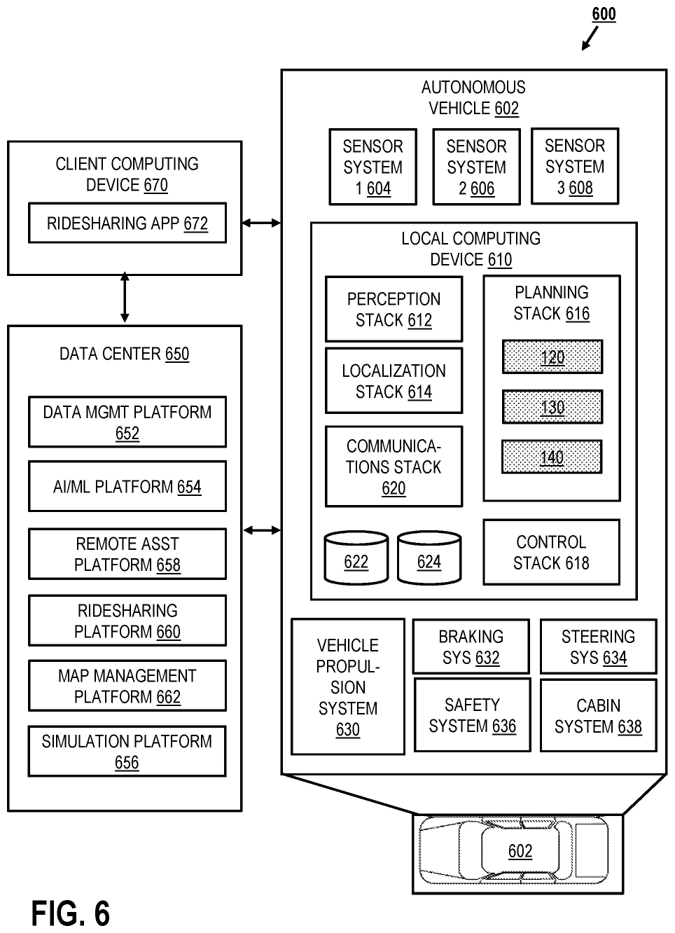

Turning now to FIG. 6, this figure illustrates an example of an AV management system 600, in which some of the aspects of the present disclosure can be implemented. One of ordinary skill in the art will understand that, for the AV management system 600 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. AV 602 may be an example of AV 136 in the Figures. The AV 602, the data center 650, and the client computing device 670 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 may navigate about roadways without a human driver based on sensor signals generated by multiple sensor systems 604, 606, and 608. The sensor systems 604-608 may include different types of sensors and may be arranged about the AV 602. For instance, the sensor systems 604-608 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 may be a camera system, the sensor system 606 may be a LIDAR system, and the sensor system 608 may be a RADAR system. Other embodiments may include any other number and type of sensors.

AV 602 may also include several mechanical systems that may be used to maneuver or operate AV 602. For instance, the mechanical systems may include vehicle propulsion system 630, braking system 632, steering system 634, safety system 636, and cabin system 638, among other systems. Vehicle propulsion system 630 may include an electric motor, an internal combustion engine, or both. The braking system 632 may include an engine brake, a wheel braking system (e.g., a disc braking system that utilizes brake pads), hydraulics, actuators, and/or any other suitable componentry configured to assist in decelerating AV 602. The steering system 634 may include suitable componentry configured to control the direction of movement of the AV 602 during navigation. Safety system 636 may include lights and signal indicators, a parking brake, airbags, and so forth. The cabin system 638 may include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 may include one or more client interfaces (e.g., GUIs, Voice User Interfaces (VUIs), etc.) for controlling certain aspects of the mechanical systems 630-638.

AV 602 may additionally include a local computing device 610 that is in communication with the sensor systems 604-608, the mechanical systems 630-638, the data center 650, and the client computing device 670, among other systems. The local computing device 610 may include one or more processors and memory, including instructions that may be executed by the one or more processors. The instructions may make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616 (e.g., having planning stack 250 of FIG. 2), a control stack 618, a communications stack 620, an HD geospatial database 622, and an AV operational database 624, among other stacks and systems.

Perception stack 612 may enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 may detect and classify objects and determine their current and predicted locations, speeds, directions, and the like. In addition, the perception stack 612 may determine the free space around the AV 602 (e.g., to maintain a safe distance from other objects, change lanes, park the AV, etc.). The perception stack 612 may also identify environmental uncertainties, such as where to look for moving objects, flag areas that may be obscured or blocked from view, and so forth.

Mapping and localization stack 614 may determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 may compare sensor data captured in real-time by the sensor systems 604-608 to data in the HD geospatial database 622 to determine its precise (e.g., accurate to the order of a few centimeters or less) position and orientation. The AV 602 may focus its search based on sensor data from one or more first sensor systems (e.g., GPS) by matching sensor data from one or more second sensor systems (e.g., LIDAR). If the mapping and localization information from one system is unavailable, the AV 602 may use mapping and localization information from a redundant system and/or from remote data sources.

The planning stack 616 may determine how to maneuver or operate the AV 602 safely and efficiently in its environment. For instance, the planning stack 616 may produce a plan for the AV 602. The plan may include a reference trajectory. The planning stack 616 may include a plurality of planners, including two or more of the following: planners_{1 . . . N} 102, and fallback planner(s) 106 in the Figures. Depending on the implementation, planning stack 616 may include scenario manager 120, mission manager 130, and fallback manager 140 in the Figures. For example, the planning stack 616 may receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 602 from one point to another. The planning stack 616 may determine multiple sets of one or more mechanical operations that the AV 602 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 616 may select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 may manage the operation of the vehicle propulsion system 630, the braking system 632, the steering system 634, the safety system 636, and the cabin system 638. The control stack 618 may receive sensor signals from the sensor systems 604-608 as well as communicate with other stacks or components of the local computing device 610 or a remote system (e.g., the data center 650) to effectuate the operation of the AV 602. For example, the control stack 618 may implement the final path or actions from the multiple paths or actions provided by the planning stack 616. The implementation may involve turning the routes and decisions (e.g., a plan) from the planning stack 616 into commands for the actuators that control the AV's steering, throttle, brake, and drive unit.

The communication stack 620 may transmit and receive signals between the various stacks and other components of the AV 602 and between the AV 602, the data center 650, the client computing device 670, and other remote systems. The communication stack 620 may enable the local computing device 610 to exchange information remotely over a network. The communication stack 620 may also facilitate local exchange of information, such as through a wired connection or a local wireless connection.

The HD geospatial database 622 may store HD maps and related data of the streets upon which the AV 602 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 624 may store raw AV data generated by the sensor systems 604-608 and other components of the AV 602 and/or data received by the AV 602 from remote systems (e.g., the data center 650, the client computing device 670, etc.). In some embodiments, the raw AV data may include HD LIDAR point cloud data, image or video data, RADAR data, GPS data, and other sensor data that the data center 650 may use for creating or updating AV geospatial data as discussed further below with respect to FIG. 5 and elsewhere in the present disclosure.

The data center 650 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 650 may include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 may send and receive various signals to and from the AV 602 and the client computing device 670. These signals may include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 may access data stored by the data management platform 652 to provide their respective services.

The AI/ML platform 654 may provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists may prepare data sets from the data management platform 652; select, design, and train machine learning models; evaluate, refine, and deploy the models; maintain, monitor, and retrain the models; and so on.

The remote assistance platform 658 may generate and transmit instructions regarding the operation of the AV 602. For example, in response to an output of the AI/ML platform 654 or other system of the data center 650, the remote assistance platform 658 may prepare instructions for one or more stacks or other components of the AV 602. Remote assistance platform 658 may provide remote assistance related functionalities as discussed with the Figures (e.g., remote assistance service 192 of FIG. 1).

The ridesharing platform 660 may interact with a customer of a ridesharing service via a ridesharing application 672 executing on the client computing device 670. Ridesharing platform 660 may provide delivery services as well. Ridesharing platform 660 may provide dispatch related functionalities as discussed with the Figures (e.g., dispatch service 182 of FIG. 1). The client computing device 670 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 672. The client computing device 670 may be a customer's mobile computing device or a computing device integrated with the AV 602 (e.g., the local computing device 610). The ridesharing platform 660 may receive requests to be picked up or dropped off from the ridesharing application 672 and dispatch the AV 602 for the trip.

Map management platform 662 may provide a set of tools for the manipulation and management of geographic and spatial (geospatial) and related attribute data. The data management platform 652 may receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data may be processed, and map management platform 662 may render base representations (e.g., tiles (2D), bounding volumes (3D), etc.) of the AV geospatial data to enable users to view, query, label, edit, and otherwise interact with the data. Map management platform 662 may manage workflows and tasks for operating on the AV geospatial data. Map management platform 662 may control access to the AV geospatial data, including granting or limiting access to the AV geospatial data based on user-based, role-based, group-based, task-based, and other attribute-based access control mechanisms. Map management platform 662 may provide version control for the AV geospatial data, such as to track specific changes that (human or machine) map editors have made to the data and to revert changes when necessary. Map management platform 662 may administer release management of the AV geospatial data, including distributing suitable iterations of the data to different users, computing devices, AVs, and other consumers of HD maps. Map management platform 662 may provide analytics regarding the AV geospatial data and related data, such as to generate insights relating to the throughput and quality of mapping tasks.

In some embodiments, the map viewing services of map management platform 662 may be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit enroute to a pick-up or drop-off location, and so on. Remote assistance platform 658 may include remote assistant agents and/or incident experts. Remote assistance platform 658 may provide remote assistance related functionalities as described in relation to the Figures.

### Exemplary Processor-Based System

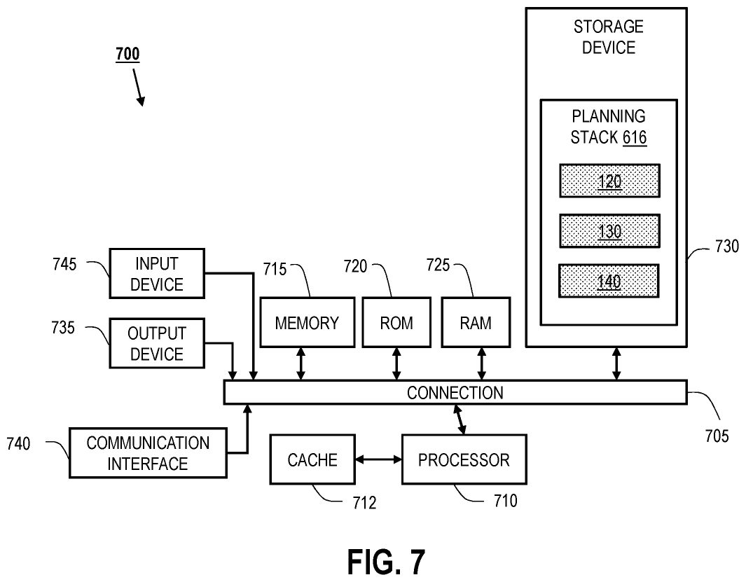

FIG. 7 illustrates an example processor-based system with which some aspects of the subject technology may be implemented. For example, processor-based system 700 may be any computing device making up, or any component thereof in which the components of the system are in communication with each other using connection 705. Connection 705 may be a physical connection via a bus, or a direct connection into processor 710, such as in a chipset architecture. Connection 705 may also be a virtual connection, networked connection, or logical connection.

In some embodiments, computing system 700 represents the local computing device 610 of FIG. 6. In some embodiments, one or more of the described system components represents many such components each performing some or all of the function for which the component is described. In some embodiments, the components may be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 may include a cache of high-speed memory 712 connected directly with, in close proximity to, or integrated as part of processor 710.

Processor 710 may include any general-purpose processor and a hardware service or software service, such as executable instructions that implement functionalities carried out by planning stack 616 (having e.g., components 120, 123, and 140) as illustrated in the Figures. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms known to those of skill in the art. In some instances, multimodal systems may enable a user to provide multiple types of input/output to communicate with computing system 700. Computing system 700 may include communications interface 740, which may generally govern and manage the user input and system output. The communication interface may perform or facilitate receipt and/or transmission of wired or wireless communications via wired and/or wireless transceivers.

Storage device 730 may be a non-volatile and/or non-transitory and/or computer-readable memory device and may be a hard disk or other types of computer-readable media which may store data that are accessible by a computer.

Storage device 730 may include software services, servers, services, etc., that when the code that defines such software is executed by the processor 710, it causes the system 700 to perform a function. In some embodiments, a hardware service that performs a particular function may include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Select Examples

Example 1 is a computer-implemented method for interrupting a mission of a vehicle, comprising: while the vehicle is completing a mission, determining a presence of a first trigger; determining a first stopping maneuver corresponding to the first trigger; interrupting the mission by attempting the first stopping maneuver by causing a planning stack of the vehicle to execute the first stopping maneuver; and in response to crossing a distance traveled threshold or an expiration of a timer before the first stopping maneuver is successfully completed by the vehicle, attempting a second stopping maneuver based on an escalation ladder corresponding to the first trigger, and causing the planning stack of the vehicle to execute the second stopping maneuver.

In Example 2, the computer-implemented method of Example 1 can optionally include the vehicle being an autonomous vehicle.

In Example 3, the computer-implemented method of Example 1 or 2 can optionally include the mission being a leg of an operational assignment assigned to the vehicle.

In Example 4, the computer-implemented method of any one of Examples 1-3 can optionally include the mission comprising one or more local goals.

In Example 5, the computer-implemented method of any one of Examples 1-4 can optionally include completing a mission comprising stopping at or driving past a waypoint.

In Example 6, the computer-implemented method of any one of Examples 1-5 can optionally include the escalation ladder comprising an ordered sequence of stopping maneuvers to attempt.

In Example 7, the computer-implemented method of any one of Examples 1-6 can optionally include determining the presence of the first trigger comprising listening for active triggers on input signals.

In Example 8, the computer-implemented method of any one of Examples 1-7 can optionally include interrupting the mission comprising triggering the planning stack of the vehicle to complete the first stopping maneuver as a new goal of the mission.

In Example 9, the computer-implemented method of any one of Examples 1-8 can optionally include determining the first stopping maneuver comprising determining a stopping maneuver in a first position in the escalation ladder corresponding to the first trigger.

In Example 10, the computer-implemented method of any one of Examples 1-9 can optionally include crossing the distance traveled threshold comprising: measuring a distance traveled by the vehicle since attempting the first stopping maneuver began; and checking if the distance traveled exceeds the distance traveled threshold.

In Example 11, the computer-implemented method of any one of Examples 1-10 can optionally include: the timer measuring an amount of time elapsed since attempting the first stopping maneuver began; and the timer checking if the amount of time lapsed exceeds a timer threshold.

In Example 12, the computer-implemented method of any one of Examples 1-11 can optionally include: causing the planning stack of the vehicle to execute the first stopping maneuver comprising causing a primary planner of the vehicle to execute the first stopping maneuver; and causing the planning stack of the vehicle to execute the second stopping maneuver comprising causing a fallback planner of vehicle to execute the second stopping maneuver.

In Example 13, the computer-implemented method of any one of Examples 1-12 can optionally include: determining that the first trigger is no longer present; and resuming the mission by causing the planning stack to cease executing the first stopping maneuver or the second stopping maneuver, and executing a goal that continues the mission.

In Example 14, the computer-implemented method of any one of Examples 1-13 can optionally include: determining that the first trigger is no longer present; and receiving a new mission; initiating a new mission by causing the planning stack to cease executing the first stopping maneuver or the second stopping maneuver, and executing a goal of the new mission.

In Example 15, the computer-implemented method of any one of Examples 1-14 can optionally include: while the vehicle is completing the mission, determining a presence of a second trigger in addition to the first trigger; and determining a second stopping maneuver corresponding to the second trigger; wherein the first stopping maneuver is attempted if the first stopping maneuver is more urgent than the second stopping maneuver.

In Example 16, the computer-implemented method of any one of Examples 1-15 can optionally include: while the vehicle is completing the mission, determining a presence of a second trigger in addition to the first trigger; wherein the first stopping maneuver corresponding to the first trigger is attempted if the first trigger has a higher priority than the second trigger.

Example 17 is a computer-implemented method for continuing an interrupted mission of a vehicle, comprising: while the vehicle is completing a mission, determining a presence of a trigger; determining a stopping maneuver corresponding to the trigger; interrupting the mission by attempting the stopping maneuver by causing a planning stack of the vehicle to execute the stopping maneuver; determining that the vehicle has completed the stopping maneuver; in response to determining the vehicle is able to self-recover, causing the vehicle to perform self-recovery; and in response to determining that the trigger is no longer present (self-recovery was successful), resuming the mission or initiating a new mission.

In Example 18, the computer-implemented method of Example 17 can optionally include: in response to determining the vehicle is unable to self-recover, triggering a vehicle retrieval event.

Example 19 is a computer-implemented method for continuing an interrupted mission of a vehicle, comprising: while the vehicle is completing a mission, determining a presence of a trigger; determining a stopping maneuver corresponding to the trigger; interrupting the mission by attempting the stopping maneuver by causing a planning stack of the vehicle to execute the stopping maneuver; publishing, to an incident expert, the trigger, a mission interrupted state, and the stopping maneuver being attempted; initiating a session with the incident expert; receiving a request to clear or remove the trigger from the incident expert; and in response to determining that the trigger is no longer present, resuming the mission or imitating a new mission.

In Example 20, the computer-implemented method of Example 19 can optionally include the new mission is specified by the incident expert.

In Example 21, the computer-implemented method of Example 19 or 20 can optionally include: in response to determining that the trigger is no longer present, publishing a mission active state.

Example 22 is a computer-implemented method for interrupting a mission of a vehicle, comprising: while the vehicle is completing a mission, determining a presence of a trigger; determining a first stopping maneuver corresponding to a trigger; determining an earliest or nearest predicted interval to complete the first stopping maneuver; in response to the earliest or nearest predicted interval being insufficient to complete the first stopping maneuver according to the escalation policy, attempt a second stopping maneuver based on the escalation policy corresponding to the trigger by causing a planning stack of the vehicle to execute a second stopping maneuver.

Example 23 is a computer-implemented method for interrupting a mission of a vehicle, comprising: subscribing to input signals representing active and inactive triggers; while the vehicle is completing a mission, detecting a first active trigger in the input signals; interrupting the mission by causing a planning stack of the vehicle to execute one or more first stopping maneuvers according to a first escalation policy corresponding to the first active trigger; while the planning stack is executing the first escalation policy, detecting a second active trigger having a higher priority than the second trigger; and causing the planning stack of the vehicle to execute one or more second stopping maneuvers according to a second escalation policy corresponding to the first active trigger.

Example 24 is a computer-implemented system, comprising: one or more processing units; and one or more non-transitory computer-readable media storing instructions, when executed by the one or more processing units, cause the one or more processing units to perform any one of the computer-implemented methods of 1-23.

Example 25 includes one more non-transitory computer-readable media storing instructions, when executed by the one or more processing units, cause the one or more processing units to perform any one of the computer-implemented methods of 1-23.

Example 26 is an apparatus comprising means to carry out or implement any one of the computer-implemented methods of 1-23.

What is claimed is:

1. A computer-implemented method for interrupting a mission of a vehicle, comprising:
while the vehicle is completing a mission, determining a presence of a first trigger;
determining a first stopping maneuver corresponding to the first trigger;
interrupting the mission by attempting the first stopping maneuver by causing a planning stack of the vehicle to execute the first stopping maneuver; and
in response to crossing a distance traveled threshold or an expiration of a timer before the first stopping maneuver is successfully completed by the vehicle,
attempting a second stopping maneuver based on an escalation ladder corresponding to the first trigger, and
causing the planning stack of the vehicle to execute the second stopping maneuver.

2. The computer-implemented method of claim 1, wherein:
the mission is a leg of a operational assignment assigned to the vehicle.

3. The computer-implemented method of claim 1, wherein:
the mission comprises one or more local goals.

4. The computer-implemented method of claim 1, wherein completing a mission comprises stopping at or driving past a waypoint.

5. The computer-implemented method of claim 1, wherein the escalation ladder comprises an ordered sequence of stopping maneuvers to attempt.

6. The computer-implemented method of claim 1, wherein determining the presence of the first trigger comprises listening for active triggers on input signals.

7. The computer-implemented method of claim 1, wherein interrupting the mission comprises triggering the planning stack of the vehicle to complete the first stopping maneuver as a new goal of the mission.

8. The computer-implemented method of claim 1, wherein determining the first stopping maneuver comprises determining a stopping maneuver in a first position in the escalation ladder corresponding to the first trigger.

9. The computer-implemented method of claim 1, wherein crossing the distance traveled threshold comprises:
measuring a distance traveled by the vehicle since attempting the first stopping maneuver began; and
checking if the distance traveled exceeds the distance traveled threshold.

10. The computer-implemented method of claim 1, wherein:
the timer measures an amount of time elapsed since attempting the first stopping maneuver began; and
the timer checks if the amount of time lapsed exceeds a timer threshold.

11. The computer-implemented method of claim 1, wherein:
causing the planning stack of the vehicle to execute the first stopping maneuver comprises causing a primary planner of the vehicle to execute the first stopping maneuver; and
causing the planning stack of the vehicle to execute the second stopping maneuver comprises causing a fallback planner of vehicle to execute the second stopping maneuver.

12. The computer-implemented method of claim 1, further comprising:
determining that the first trigger is no longer present; and
resuming the mission by causing the planning stack to cease executing the first stopping maneuver or the second stopping maneuver, and executing a goal that continues the mission.

13. The computer-implemented method of claim 1, further comprising:
determining that the first trigger is no longer present;
receiving a new mission; and
initiating a new mission by causing the planning stack to cease executing the first stopping maneuver or the second stopping maneuver, and executing a goal of the new mission.

14. The computer-implemented method of claim 1, further comprising:
while the vehicle is completing the mission, determining a presence of a second trigger in addition to the first trigger; and
determining a second stopping maneuver corresponding to the second trigger;
wherein the first stopping maneuver is attempted if the first stopping maneuver is more urgent than the second stopping maneuver.

15. The computer-implemented method of claim 1, further comprising:
while the vehicle is completing the mission, determining a presence of a second trigger in addition to the first trigger;
wherein the first stopping maneuver corresponding to the first trigger is attempted if the first trigger has a higher priority than the second trigger.

16. A computer-implemented method for continuing an interrupted mission of a vehicle, comprising:
while the vehicle is completing a mission, determining a presence of a trigger;
determining a stopping maneuver corresponding to the trigger;
interrupting the mission by attempting the stopping maneuver by causing a planning stack of the vehicle to execute the stopping maneuver;
determining that the vehicle has completed the stopping maneuver;
in response to determining the vehicle is able to self-recover, causing the vehicle to perform self-recovery; and
in response to determining that the trigger is no longer present, resuming the mission or initiating a new mission.

17. The computer-implemented method of claim 16, further comprising:
in response to determining the vehicle is unable to self-recover, triggering a vehicle retrieval event.

18. A computer-implemented method for continuing an interrupted mission of a vehicle, comprising:
while the vehicle is completing a mission, determining a presence of a trigger;
determining a stopping maneuver corresponding to the trigger;
interrupting the mission by attempting the stopping maneuver by causing a planning stack of the vehicle to execute the stopping maneuver;
publishing, to an incident expert, the trigger, a mission interrupted state, and the stopping maneuver being attempted;
initiating a session with the incident expert;
receiving a request to clear or remove the trigger from the incident expert; and
in response to determining that the trigger is no longer present, resuming the mission or imitating a new mission.

19. The computer-implemented method of claim 18, wherein the new mission is specified by the incident expert.

20. The computer-implemented method of claim 18, further comprising:
in response to determining that the trigger is no longer present, publishing a mission active state.
